(19) United States
(12) Patent Application Publication
(10) Pub. No.: US 2008/0299817 A1
(43) Pub. Date: Dec. 4, 2008

(54) Structure of lamp socket in lamp string

(76) Inventor: Chih-Ping Liu, Banciao City (TW)

Correspondence Address: BACON & THOMAS, PLLC, 625 SLATERS LANE, FOURTH FLOOR, ALEXANDRIA, VA, 22314-1176, US

(21) Appl. No.: 11/806,289

(22) Filed: May 31, 2007

(51) Int. Cl. H01R 4/24

(52) U.S. Cl. 439/419

(57) ABSTRACT

The present invention relates to a “structure of lamp socket in lamp string”, particularly for one having contrivance of (elastic plate) and (electric conducting plate) so that the rest (illuminant elements) in the lamp string can maintain illuminating and glittering even falling off of any (illuminant elements).

### TECHNICAL FIELD OF THE INVENTION

The present invention relates to a “structure of lamp socket in lamp string”, particularly for one having contrivance of (elastic plate) and (electric conducting plate) so that the rest (illuminant elements) in the lamp string can maintain illuminating and glittering even falling off of any (illuminant elements).

### PRIOR ART OF THE INVENTION

With compatriot paying more attention to the celebrating ambience of festival day by day, no matter birthday party, marriage festivities, even Western Christmas Day and the like, the ambient construction of festival atmosphere is always unavoidable, the arrangement of lamp string at festival venue is most often used in building such atmosphere at present, by means of lamp string embellishing around festival venue so that the lamp string can illuminate and glitter among festival venue to achieve the effect in building the festival atmosphere.

Please refer to FIGS. 1A and 1B of the structural and embodiment schematic views of conventional “structure of lamp socket in lamp string”, it mainly comprises a lamp base 10, which has a holding receptacle 11 disposed therein to accommodate the lamp stem 12, and which also has the electric conducting plates 13 disposed therein to connect with electric source wires 14; Wherein, said lamp stem 12 has the electric conducting claw 16 of the bulb 15 plugged thereon. When the lamp stem 12 inserts and fixes in the lamp base 10, the electric conducting claws 16 will join and conduct each other with the electric conducting plate 13 in said lamp base 10 to enable said bulb 15 illuminate and glitter. Thereby, because all the lamp sockets in such lamp string adopt the same structure, by means of the connection of the electric source wires 14, an electric circuit loop consisting of said electric conducting plate 13 and the filament of said bulbs 15 is formed so that all said bulbs 15 on such lamp string will illuminate and glitter at the same time;

However, if anyone one of foregoing electric conducting plate 13, electric source wires 14 or bulbs 15 is removed, the electric circuit loop is cut off and results in all the rest bulbs 15 on lamp string come off and stop; Thereby, during practical operation, it not only causes user much inconvenience but also considerably incurs the fixing time and cost of maintenance due to falling of the bulb 15; Thus, it is really very inconvenient and regrettable. Therefore, the aforesaid conventional commodity is really not a good contrivance with some existing drawbacks to be urgently improved. In view of that facts with foregoing conventional lamp socket in the lamp string, the inventor of the present invention is eager to improve it innovatively, after painstaking effort to diligently study and research for many years, the “structure of lamp socket in lamp string” of the present invention is successfully accomplished eventually.

### CONTENT OF THE PRESENT INVENTION

A “structure of lamp socket in lamp string”, which can achieve the objects of the present invention, comprises a lamp base, which has a holding receptacle disposed therein to accommodate and fix following lamp stem, and said holding receptacle has two electric conducting plates configured respectively on both inner walls thereof such that each of said electric conducting plate connecting and conducting with an electric source wire each other at each underside separately; Beside, a pair of elastic plates are disposed on each said electric conducting plate respectively so that both of said elastic plates are able to resiliently contact each other; and a lamp stem, which has an illuminant element insetting recess with fixing holes disposed thereon so that said fixing holes will be inserted and secured by said electric conducting claws, which will be held firmly on the outer rim of the lamp stem at the same time, when illuminant element is inset and fixed in said illuminant element insetting recess; Besides, a clip end extends downwards at the bottom end of the lamp stem;

When the lamp stem is plugged and fixed in the lamp base, said lamp stem will be secured in the holding receptacle of lamp base, and the clip end will be inserted and grasped properly between the pair of elastic plates; Meanwhile, the electric conducting claws of illuminant element keep in touch and conducting with the electric conducting plates for fixing reinforcement effect of the lamp stem effectively by means of elastic plates so as to have the illuminant element achieved the purpose of illuminating and glittering light; During in operation, if the illuminant element with lamp stem falls off or being removed, the pair of elastic plates in the lamp base will rebound in touch flexibly each other again at this moment by resilience thereof and then further form a electric circuit loop together with the electric conducting plates and the electric source wires via said elastic plates without influence to the whole operational effect of the lamp string.

### SUMMARY OF THE PRESENT INVENTION

The primary object of the present invention is to provide a “structure of lamp socket in lamp string” with contrivance of (elastic plate) and (electric conducting plate) so that the (electric conducting plate) can keep effectively closed contact by means of resilient force of the (elastic plate) so as to have rest (illuminant elements) in the lamp string maintained illuminating and glittering in the consequence of electric circuit continuity even falling off of any (illuminant elements).

The next object of the present invention is to provide a “structure of lamp socket in lamp string” with contrivance of (elastic plate) and (electric conducting plate) in the manner of two separated pieces so that the resilience for contact of the (elastic plate) can be enhanced effectively.

Another object of the present invention is to provide a “structure of lamp socket in lamp string” with feature of simple structure and easiness of manufacturing production.

The other object of the present invention is to provide a “structure of lamp socket in lamp string” with feature of simple operation and easiness of replacement as well as effective mark down of the maintenance cost.

### BRIEF DESCRIPTION OF THE DRAWINGS

FIGS. 1A and 1B are the structural and operational schematic view respectively of the conventional “loam socket in lamp string”;

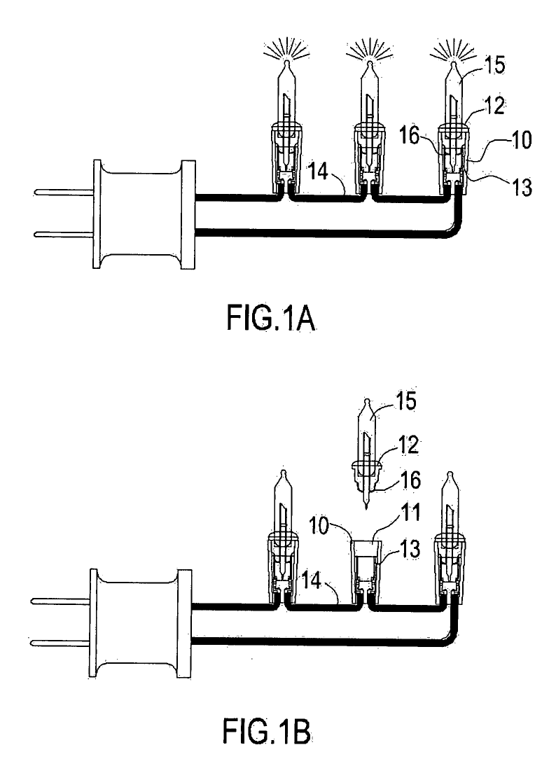

FIG. 2 is the exploded structural schematic view in the “structure of lamp socket in lamp string” for the present invention;

FIG. 3 is the assembly structural schematic view in the “structure of lamp socket in lamp string” for the present invention;

FIG. 4 is the exploded section perspective structural schematic view in the “structure of lamp socket in lamp string” for the present invention;

FIG. 5 is the assembly section perspective structural schematic view in the “structure of lamp socket in lamp string” for the present invention; and

FIGS. 6A and 6B are the operational schematic views of the exemplary embodiment in the “structure of lamp socket in lamp string” for the present invention.

### DETAILED DESCRIPTION OF THE PREFERRED EMBODIMENT

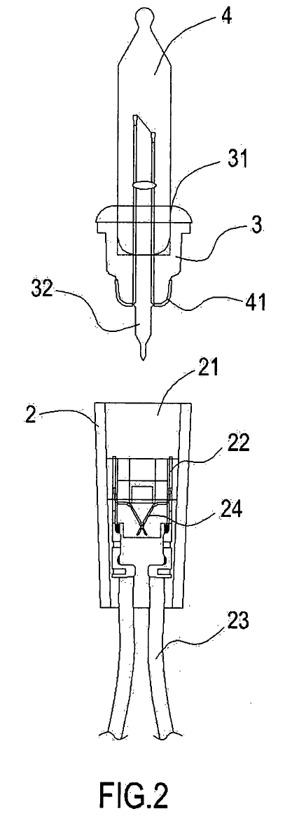

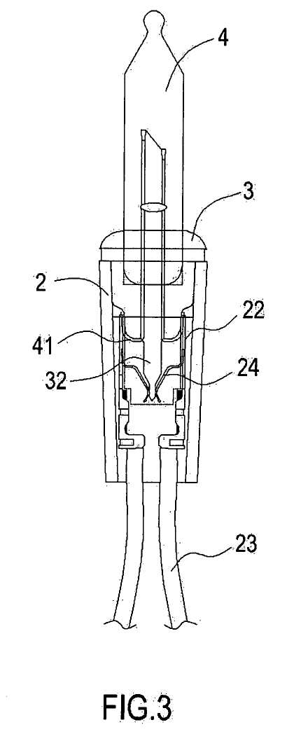

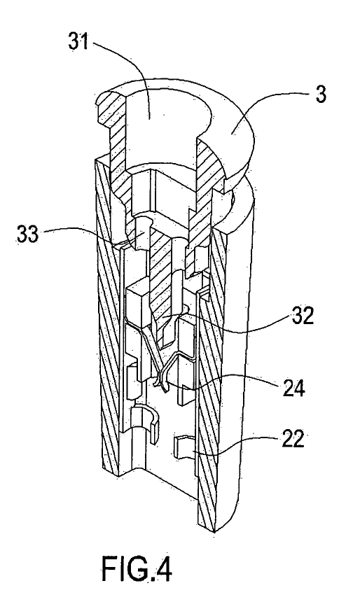

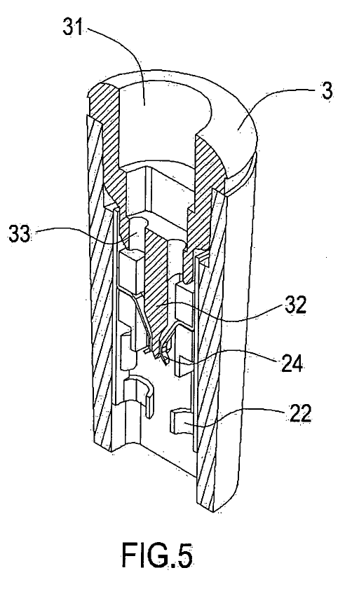

Please refer to the FIG. 2 through FIG. 5, the exploded, assembly and exploded section perspective as well as assembly section perspective structural schematic views in the “structure of lamp socket in lamp string” for the present invention comprises:

a lamp base 2, which has a holding receptacle 21 disposed therein to accommodate and fix following lamp stem 3, and said holding receptacle 21 has two electric conducting plates 22 configured respectively on both inner walls thereof such that each of said electric conducting plate 22 connecting and conducting with an electric source wire 23 each other at each underside separately; Beside, a pair of elastic plates 24 are disposed on each said electric conducting plate 22 respectively so that both of said elastic plates 24 are able to resiliently contact each other so as to make an electric circuit loop together with said electric conducting plate 22 and electric source wire 23; and

a lamp stem 3, which has an illuminant element insetting recess 31 with fixing holes 32 disposed thereon so that said fixing holes 32 will be inserted and secured by said electric conducting claws 41, which will be held firmly on the outer rim of the lamp stem 3 at the same time, when illuminant element 4 is inset and fixed in said illuminant element insetting recess 31; Besides, a clip end 32 extends downwards at the bottom end of the lamp stem 3, wherein the illuminant element 4 can be either bulb 15 or LED;

When the lamp stem 3 is plugged and fixed in the lamp base 2, said lamp stem 3 will be secured in the holding receptacle 21 of lamp base 2, and the clip end 32 will be inserted and grasped properly between the pair of elastic plates 24 in the lamp base 2; Meanwhile, the electric conducting claws 41 of illuminant element 4 keep in touch and conducting with the electric conducting plates 22 for fixing reinforcement effect of the lamp stem 3 effectively by means of elastic plates 24 so as to have the illuminant element 4 achieved the purpose of illuminating and glittering light;

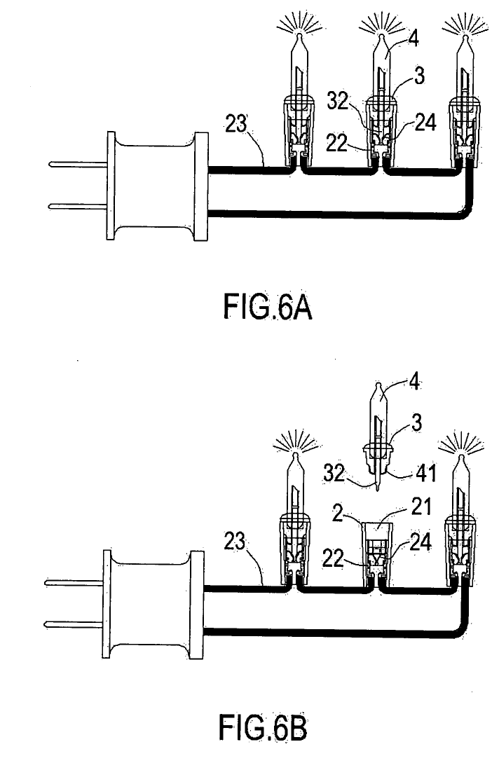

Please refer to FIGS. 6A and 6B, which are the operational schematic views of the exemplary embodiment in the “structure of lamp socket in lamp string” for the present invention. When the user is in operation, if the illuminant element 4 with lamp stem 3 falls off or being removed, the pair of elastic plates 24 in the lamp base 2 will rebound in touch flexibly each other again at this moment by resilience thereof and then further form a electric circuit loop together with the electric conducting plates 22 and the electric source wires 23 via said elastic plates 24 without influence to the whole operational effect of the lamp string due to the falling off or removal of the illuminant element 4; Thus, it can greatly improve the integral practicability and convenience;

The foregoing elaboration heretofore is only the concrete description of the preferred exemplary embodiment of the feasible mode for the present invention, which is not intended to limit the patent claim of the present invention. Any equivalent embodiment or alteration, which does not depart from the technological spirit and essence of the present invention, should be included in the patent claims of the present invention.

What is claimed is:

1. A “structure of lamp socket in lamp string” comprises:
a lamp base, which has a holding receptacle disposed therein, and said holding receptacle has two electric conducting plates configured respectively on both inner walls thereof such that each of said electric conducting plate connecting and conducting with an electric source wire each other at each underside separately; Beside, a pair of elastic plates are disposed on each said electric conducting plate respectively so that both of said elastic plates are able to resiliently contact each other; and
a lamp stem, which has an illuminant element disposed thereon and a clip end extends downwards at the bottom end thereof; When the lamp stem is plugged and fixed in the lamp base, said lamp stem will be secured in the holding receptacle of lamp base, and the clip end will be inserted and grasped properly between the pair of elastic plates in the lamp base; Meanwhile, the electric conducting claws of illuminant element keep in touch and conducting with the electric conducting plates;

2. The “structure of lamp socket in lamp string” as recited in the claim 1, wherein, said lamp stem has an illuminant element insetting recess with fixing holes disposed thereon so that said fixing holes will be inserted and secured by said electric conducting claws when illuminant element is inset and fixed in said illuminant element insetting recess.
